(19) United States
(12) Patent Application Publication
(10) Pub. No.: US 2006/0064295 A1
(43) Pub. Date: Mar. 23, 2006

(54) Method and device for the simulation of non-linear dependencies between physical entities and influence factors measured with sensors on the basis of a micro-simulation approach using probabilistic networks embedded in objects

(75) Inventors: Arndt Schwaiger, Saarbrucken (DE); Bjorn Stahmer, Saarbrucken (DE); Christian Russ, Ensdorf (DE)

Correspondence Address: SQUIRE, SANDERS & DEMPSEY L.L.P, 600 HANSEN WAY, PALO ALTO, CA, 94304-1043, US

(73) Assignee: DACOS Software GmbH, Saarbrucken (DE)

(21) Appl. No.: 11/228,645

(22) Filed: Sep. 15, 2005

(30) Foreign Application Priority Data
Sep. 17, 2004 (DE) 10 2004 045 610.0
Oct. 15, 2004 (DE) 10 2004 050 505.5

(51) Int. Cl. G06F 9/45

(52) U.S. Cl. 703/22

(57) ABSTRACT

The invention pertains to a method for modeling and simulating entities whose interdependencies, as well as the resulting system behavior, can be used to make statements about real behavior. It is comprised of the following steps: the real entities are each represented by an individual software-object which stores the individual behavior of the corresponding entity, wherein this behavior is extracted from real data about the entity and its environment using machine learning methods, in order to then store the individual behavior within the software-object via a set of probabilistic networks (PN), wherein each PN models one sub-behavior of the entity as quantified linear or non-linear dependencies between a set of influence factors and behavior aspects, the influence factors and behavior aspects are represented by the corresponding nodes in the PN. The global interdependencies between the entities are extracted from real data and stored as linear or non-linear dependencies between the entities in the meta-PN and the meta-PN are generated by merging local PNs and by adding the extracted global interdependencies.

### TECHNICAL FIELD

The invention refers to a computer-assisted simulation and system control. It comprises a method for the scalable modeling, analysis, simulation and prognosis of the behavior of individual physical entities (micro-simulation), as well as the overall systemic behavior of a set of entities emerging from their interdependent interactions. This information can be used for control purposes (for the direct adaptation of the resource supply to the system behavior or for the indirect adaptation of the system behavior to resource availability).

In doing so, the entity's patterns of behavior and behavior interdependencies are represented by probabilistic networks whose structure codes the knowledge about the behavior of and interdependencies between the behaviors of entities. At the same time, all types of entities can interact. The patterns of behavior are extracted from data which is continually measured (for example: sensor data, mobile radio data, etc.) or from older data which has been saved. A storage device is required for this.

In addition, the invention comprises an object-oriented software-architecture which implements the above method of simulation. The software-architecture includes an architecture for a simulation environment and an architecture for probabilistic networks embedded in software-objects.

### BACKGROUND OF THE INVENTION

The simulation method and architecture can be used to simulate and forecast the overall behavior of a system constructed of entities subject to the influences or effects (for example: date, day of the week, time, weather etc.) on the individual entities, in order to then either
directly and proactively adapt the assignment of resources to the forecasted behavior of the entities and the overall system by controlling physical devices (Use case 1) or
indirectly and proactively adapt the behavior of the entities in a system to the forecasted resource availability. With the help of the technology described we first analyze and test by way of simulation which influences the system should be exposed to, in order to effectuate the adaptation of its behavior to the resource availability and to subsequently create these influences by controlling physical devices (Use case 2).

The actions and reactions of physical entities in the real world (such as, human and animal individuals, machines (for example: cars and other means of transportation, etc.) are influenced by physical magnitudes (influence/environment factors), which can be perceived by said entities via sensors. This also applies for the actions and reactions of non-physical entities (software-objects, software-agents, softbots, etc.).

These perceived environment factors result from actions controlled autonomously by other entities, as well as stochastic changes in the environment (for example: temperature, humidity, etc.) which cannot be controlled by the entities. The individual behavior resp. the number and type of actions carried out by an entity are subject to the type resp. combination of environment factors perceived by it. Some or all of an entity's actions can thereby become environment factors for other entities which then, in turn, influence their behavior and so forth, so that these entities build a system in which an interdependent systemic overall behavior emerges.

There are many systems in day-to-day life to which the above characterization applies, for example in the areas of “traffic management systems” and “cellular phone networks”. This is also the case in the areas “stock markets”, “welfare systems” or “consumer behavior”.

Due to its relevancy, consolidated efforts have been made in the last few years to better understand and forecast this overall behavior so dependent on a multitude of influence factors. One of the objectives here was to forecast undesired system states, such as traffic jams or cellular phone network overloads more quickly and precisely and to be able to counteract them proactively using control mechanisms. This can be very expedient in technical, as well as economic scenarios—in the case of stock market crashes, cyclical recessions, rising unemployment, etc. However, a second objective is to extract as much knowledge about the behavior of the overall system and its entities via the extraction of underlying patterns of behavior and behavior interdependencies, so that one can counteract undesired reactions from entities. This should then allow one to avoid undesired developments in an overall system, which ultimately emerge from individual reactions and to instead affect desirable system behavior by appropriately changing influence factors by controlling physical devices.

Previous methods for modeling, simulating, analyzing, forecasting and controlling the overall behavior, as well as the resource supply of such systems all have a range of disadvantages which result from their limited approach and affect their usability and efficiency.

They have, in particular, the disadvantage of not being able to pursue a micro-simulation approach. In a micro-simulation approach entities can be modeled in a simulation system so that the individual behavior of all entities, as well as the overall behavior emerging from their interaction, can be considered. The individual behavior of an entity with its interdependence to other entities and influence factors, i.e. its non-linear influences on the system behavior, are considered in the invented simulation method.

In traditional methods however, no such approach is pursued. Instead, data is often collected about the behavior of individual entities and “condensed” with statistical methods, so that the individual behavior of an entity with its interdependency to other entities and influence factors remains unconsidered. This means that either knowledge about the behavior of the individual entity is lost or knowledge about its non-linear influence on other entities in the simulation process or even both.

This results in the fact that the simulation and prognosis quality of these so-called “non-micro-simulation-systems” suffers, also, that queries to the system that can only be answered with knowledge about the individual behavior of the entities cannot be made and that analyses on the interdependencies between entities which are often the cause of unexpected system effects cannot be carried out and thus, that “non-micro-simulation-systems” are not really capable of forecasting which influences must act upon a complex system in order to move it in a desired direction.

The more complex the interactions in a system are and the more intelligent and autonomous its entities are, the more difficult it is to forecast the changes in the system's overall behavior. Because generally, with increasing complexity, its overall behavior is defined by developments which are based on non-linear influences and interdependencies between its entities and the environment influences.

### OVERVIEW OF THE INVENTION

The goal of the invention is therefore, to provide a simulation method and an architecture which embeds this method based on a probabilistic micro-simulation approach with which complex systems can be modeled, so that during the simulation process the individual behavior of each entity with its non-linear dependencies on any type of influence factors, as well as the non-linear interdependencies between the entities with their influences on the overall system behavior can be considered in the simulation process.

And in such a manner that the emerging overall behavior of a system can be simulated, forecasted and analyzed with the invention in a qualitatively new way, in order to use the knowledge derived from this to
directly adapt the resource supply proactively to the forecasted behavior of the entities resp. the system by controlling physical devices (Use case 1) or
create real influences on the system and its entities by controlling physical devices that had the desired effects on the system behavior in the virtual simulation and in doing so, control the resource consumption in the system indirectly (Use case 2).

Thus, the invention provides a method that can be used for the scalable modeling, simulation, analysis, prognosis and control of the behavior of individual entities of the real world, as well as the systemic overall behavior of a set of entities emerging from their interdependent interactions.

Here patterns of behavior and the behavior interdependencies of the entities are represented by probabilistic networks, whose structure codes the knowledge about the behavior of and interdependencies between the behaviors of entities. All entities can interact here.

Entities are represented in the system as individual software-objects. A number of probabilistic networks (PN) which model the individual behavior of the entities are imbedded in the objects. Each PN models one sub-behaviour of the entity.

Quantified non-linear dependencies between a set of influence factors (input nodes) and behavior nodes (output nodes) are extracted from real data via a machine learning-method. These dependencies are represented by conditional probabilities in the network.

The global interdependencies between the entities are modeled and represented in PNs, in addition to the local knowledge stored there. The interdependencies can be stored and generated in the entities, as well as in superordinate entities. Global interdependencies are modeled through the merging of the local PNs to meta-PNs—with a merging method (for PNs) developed by us. The merging method comprises the merging of the PNs to a meta-PN and the identification of global interdependencies. Superordinate entities represent a set of entities.

Any type of scenario can be simulated using the PNs stored in the objects. A scenario consists of combinations of concrete states of entities and/or influence factors of a system. These combinations are transferred to the networks as a sequence of network configurations. The effect of each configuration is determined using inference algorithms for PNs. The meta-PNs are used analog to the local PNs for simulating global interdependencies.

### SHORT DESCRIPTION OF THE FIGURES

FIG. 1 shows two software-objects with probabilistic networks, that are to be merged into a holonic software object;

FIG. 2 shows the merging of probabilistic networks;

FIG. 3 shows derived dependencies;

FIG. 4 shows the calculation of the MDL score

FIG. 5 shows the calculation of a logarithmic probability of possible pairs;

FIG. 6 shows a function for learning the probability of an event;

FIG. 7 shows an algorithm for learning the dependencies of holons;

FIG. 8 shows an algorithm for finding maximum equal networks;

FIG. 9 shows an algorithm for finding the same child nodes, which come from the parents;

FIG. 10 shows an algorithm for finding all paths to equal nodes.

### DESCRIPTION OF THE PREFERRED EMBODIMENTS

A simple approach to simulate and forecast the overall behavior of a system consisting of entities would be to learn about the system and its entities from data and to generate a huge probabilistic network (macro-network) in which the entities, as well as all of the influence factors are represented as nodes and in which all of the dependencies between the nodes are contained as conditional probability tables (CPT). The result would be a network with hundreds of thousands of nodes which would be unmanageable due to its complexity. To nevertheless carry out a simulation und prognosis of the global behavior in such systems, the method invented can be used.

In order to obtain comprehensive protection a process will be described in the following which as a possible embodiment consists of one or several of the following steps of which some can be also executed in different sequences:
Measurement/extraction of raw data resp. information about real entities.
Identification of the objects resp. relations relevant for the simulation.
Micro-simulation by partitioning a possible macro-network->representation of all entities via individual software objects (See Method A).
Automatic learning of individual patterns of behavior resp. relations of all entities based on their real data.
Storage of learned knowledge as probabilistic networks (PN) resp. behavior networks within the software objects (See Method A).
Several micro resp. macro-PNs can be stored in a software object. Not storing all of this in a PN reduces on the one hand, the complexity, on the other, it can serve to increase the accuracy of the prognosis (See Method A in the following).
Relations between entities are thereby modeled by meta-networks (MN) which are created by merging individual PNs and are encapsulated in group resp. meta-objects (See Method B in the following).
During the simulation process the generation/definition of one or more of the scenarios to be simulated takes place by creating special scenario-objects with scenario-parameters (influence factor values). At this point, the simulation process resp. the software objects in it are appropriately initialized with influence factor values (See Method C in the following).
Selection of the software objects necessary for the simulation subject to the parameter settings in the scenario-objects. Selecting only the subset of objects absolutely necessary (a combination of individual “micro”-objects and “macro-objects” which represent groups of objects) reduces the complexity of the simulation. For the selection of the (sub)set of objects a sort of “pre-simulation” is carried out; then the main simulation takes place (See Method C in the following).
Definition of the sequence resp. succession or order, in which the selected objects according to their reactions to the parameters in the scenario-objects—i.e. to the changes in the influence resp. environment factors—are “queried” resp. react in the main simulation. This also serves to reduce complexity. Correlations between the software objects must also be considered here (See Method C in the following).
The PNs (Probabilistic Networks) of the selected software objects are configured according to the scenario parameters in the order defined above. This results in a sequence of PN-configurations (See Method C). Specialized PN-network-topologies, based on the application, are used for the calculations (See Method D).
Expected values are calculated with the implemented inference mechanisms for the PNs from the PN-configurations in the sequence defined above for certain nodes in the PNs, wherein the expected values represent the individual reactions of the software objects to the defined scenario-parameters (See Method C in the following).
Finally, an evaluation of the scenarios takes place that is based on the calculation of selected goal variables from the generated expected values.

This results in the appropriate control of physical devices
a. in Use case 1 for the proactive adaptation of the resource supply to the entity behavior forecasted in the scenario with the highest realization probability according to the expected values generated by the method or
b. in Use case 2 for inducing the scenario-parameters of the best evaluated scenario onto the system and its entities in the real world and by doing so, provoke the desired behavior.

Different software objects can interact with each other for the improvement of the simulation results, by exchanging information and simulating reciprocal impacts.

A Telecommunication radio networks can be selected as a possible example of use (Use case 1).

The simulation method and architecture described in this application can be used to conduct so-called “Load Balancing” in a cellular phone network (for example: a GSM network) which is composed of cell-clusters each consisting of n cells which are supplied with wireless channels via transceiver stations (called Based Transceiver Stations [BTS] in GSM-networks). Within each cell-cluster, the k usable channels within the cellular phone network must be distributed resp. partitioned on the n cells so that no channel within the cell-clusters can be used twice (so-called FDMA-method, [frequency division multiple access]). This rules out overlays of the same frequencies with other signals from cells in the cluster. Instead of statically distributing the channels to the n cells in a cluster as is customary at a ratio of k:n, the distribution of the available channels to the individual cells can be dynamically, optimally and proactively adapted to the system load forecasted per time interval with the technology invented. To do so, behavior networks (cell networks) are generated resp. learned for the n cells of the cluster (Method A) which represent the mobile communication behavior of the network users within each cell cluster subject to influences (for example: date, day of the week, time, weather etc.). The resource demand per time interval to be expected in dependency on the acting influences is then simulated and forecasted by the method on the basis of these cell networks (Methods C and D). The partitioning of the available k channels to the n cells can subsequently be dynamically and proactively adapted to the forecasted demand resp. network load via a computerized control system. The modeling of the domain can be even more detailed for analysis and simulation purposes by generating behavior networks not only for the cell-clusters, but also for the individual users of the cellular phone network. This is possible, because as a rule, the users can be identified over the cellular phone or communication device being used (for example: over the SIM-card in a GSM-cell phone).

To optimize the partitioning of the channels on the cell it is often necessary to merge several cell networks to a superordinate cell-meta-network (Method B). This can become necessary when the cells within a cluster cannot all be supplied by a single transceiver station. In this case, it is not only the user-behavior within an individual cell which is relevant for the optimization of the allocation of resources in the cellular phone network, but rather the demand-patterns within the set of cells supplied with channels by the transceiver station. Their networks are merged into superordinate station-networks for this, which again can be merged into cluster-networks. This is relevant for the coordination of so-called hand-overs, when a radio network user leaves the transmission range of a cell or a station and switches to another transmission range. Further merging can be beneficial for solving superordinate problems (using methods C and D), for instance when control stations that are superordinate to the cell-clusters (called Base Station Controller [BSC] in GSM-networks) monitor and coordinate the distribution and assignment of network resources, as e.g. channels, for a multitude of cells and clusters within the cellular phone network.

Another application example is an electronic traffic management system (Use case 2).

Traffic management systems can be controlled using the system and method described in this application. The simulation method and architecture can be used first, to forecast the behavior of a traffic system with critical developments, such as traffic jams and an increasing accident rate based on prognoses on the behavior of individual road users and second, via simulations, to analyze and test which changes must be made in order to avoid the forecasted undesirable developments and third, to produce the technical-physical effects required for this by changing the control of traffic light systems/traffic management systems.

Today, a multitude of data on traffic-status is registered using instruments resp. sensors on bridges or streets and highways (see for example: truck-tolls). The same applies to data entry using sensors in vehicles (KFZ, LKW etc.) which—for example per GSM—transmit data about their speed etc. to a control center.

For traffic simulations, such data for the generation of PNs is used and stored in software-objects (Method A) which represent exactly one physical entity (vehicle, street section etc.). In doing so, the PNs learn the patterns of behavior of the vehicles, as well as standard traffic patterns which occur subject to various influence factors on different sections of the street.

The driving behavior of for example, one vehicle under the conditions of external circumstances such as weather, the street conditions and traffic is coded in a PN and can thus be used for simulations. Patterns of behavior can even be learned for individual vehicles, for the case that they (for example with tolls) carry a microprocessor with them which identifies them or they send their data to a traffic control center, in order to “guided” optimally.

Using inference methods the vehicle-objects can give information using their PNs in the simulation (Methods C and D) about how the behavior of the corresponding vehicles changes when technical effects are induced, i.e. for example sending traffic jam warnings and recommendations for speed directly to the vehicle or traffic lights or switching on electronic road signs with certain configurations of warnings, speed limits or even detour recommendations.

The decisions of the, in reality autonomous, vehicles are “re-affected” by the system through these technical effects; their reactions are then, in turn, registered by the sensors, etc.

The results of the simulations are used to find the optimal configurations for electronic traffic management systems, which then can pilot traffic optimally. Simulation results are directly translated into control signals for the automatic traffic control devices of the system.

For the simulation of traffic and the optimization of the configuration of the control system in an electronic traffic management system the merging method (Method B) is also often necessary for many problems, for example, modeling the effects of the road condition and road users on a vehicle to be simulated. A software object which represents a section of a street can, in addition, be merged with other street section objects in order to simulate the flow of traffic from one section of the street to the other.

A further advantage of the merging method is that it simplifies the accurate simulation of the behavior of groups of vehicles and even makes this possible, in part, for the first time.

Moreover, it allows the consideration of new prototypical patterns of behavior in simulation runs, for which complete data is not available resp. only inadequate real data available, because these patterns were only registered by vehicle prototypes.

Thus, the object PNs could for example, be changed using readings from vehicle-prototypes in such a manner that new prototypical patterns of behavior can be added and their efficiency tested in a simulation. And all of this, before the automobile manufacturer has even integrated the technical requirements for this into their production vehicle.

Such a pattern of behavior could be for example an “autocade”. The manufacturers at BMW and Daimler Chrysler are developing vehicle prototypes which can form a convoy on the freeway so that vehicles with the same destination can drive computer-controlled in a group with a defined distance between them and at the same speed.

A further application example is the simulation and prognosis of customer buying behavior (Use cases 1 and 2).

A supermarket wishes to simulate and forecast which articles the customers will buy, in which quantities, under certain influence factors. To do so, an individual set of PNs will be generated for each entity to be simulated, i.e. for each customer and article (Method A). The article-PNs represent the sales behavior of the article and the customer-PNs, the buying behavior of the customer. Either the retailer's existing databases are used as a source of data or the behavior of the entities is continually registered by a set of measuring devices in the showroom. The set of the PNs is encapsulated in objects, which correspond to the physical entities.

In order to record the dependencies between the entities, one would first, naively, generate a large, common network for all of the entities in which all physical entities are represented by nodes. In most cases however, this approach fails because the resulting networks are too complex and can thus, not be used for calculations. This made it necessary to develop a method that
1. Breaks this large network down in to many small, manageable networks and
2. Merges these networks back into larger sub-networks when necessary.

The following (among other things) is coded in the PN of an article: how the customers who bought this article react when it is advertised. The advertising of an article also affects other “related” articles. It is possible that articles not advertised are sold less, because only the article advertised is bought, the opposite can however, also be the case, that articles not advertised are “pulled” by the advertised article. In order to model these dependencies and use them in a simulation one needs the merging method described below (Method B).

This method can be used, when necessary, to model the effects of a customer or article on another customer resp. article. To do this, the corresponding objects are merged to meta-objects (Method B) in order to identify the dependencies between them. The resulting meta-networks are encapsulated in new software-object. Articles are combined to create article-group-objects and customers to customer-group-objects. These new objects are generated temporarily when needed and can be used as substitutes for the individual objects in the simulation.

All of the objects generated and embedded in the simulation architecture can then be used in the simulation method to simulate and forecast the projected article sales subject to the assumed influence factors such as changes in price, promotions, listing and delisting, as well as influences caused by the weather or time (Methods C and D).

The application customer buying behavior simulation can be used as an example, for both the Use case 1 and the Use case 2. Because on the one hand, the supply of the supermarket with articles via logistic measures can be directly adapted to the forecasted customer buying behavior and on the other, the buying behavior of the customer can be influenced and adapted to the availability of articles in the supermarket by way of pricing and promotion campaigns.

Another possible application is the simulation and prognosis of the effects of trade promotions in the consumer goods industry (Use cases 1 und 2).

For the purposes of manufacturers in the consumer goods industry, their retailers and rival manufacturers can be modeled as objects with encapsulated PNs (Method A), wherein the PNs represent the behavior of the corresponding retailers resp. competitors. In addition, all of the manufacturer's products, as well as the products from the competitors, can be modeled as objects with encapsulated PN, wherein the PN represent the sales behavior of the products subject to a set of influence factors.

On the basis of the probabilistic objects generated in this manner, the simulation and prognosis (Methods C and D) of the effects of so-called trade promotions (advertising efforts, rebates, special campaigns, etc.) is carried out by the manufacturer together with the retailer is possible.

If a consumer goods manufacturer has data about competitive products then the PNs from the manufacturer's products can be merged with the PNs of competitive products (Method B), analog to the use case buying behavior simulation, in order to identify the dependencies between these and to simulate the effects of a trade promotion on the respective product and its competitive products (Methods C and D). In addition, product networks can be mixed with retailer networks in order to incorporate the retailer's strategic behavior into the simulation (For example: which rebates satisfy a certain retailer, etc.).

Like the application customer buying behavior simulation, the application consumer goods industry is also valid as an example for both Use cases 1 and 2, because on the one hand, the sales of products can be directly adapted to the forecasted sales behavior of the products through logistic actions and on the other hand, the article sales behavior can be influenced by the appropriate parameterization of the trade promotions in a desired way.

In addition to the stated application examples, the method described above can also be used in many other technical and non-technical fields in accordance with the patent claims.

The methods used in the overall process will be discussed in the following:

Method A: Modeling the physical entities: The complexity is broken down “top-down” by partitioning the huge macro-network—resulting from the naive approach to the simulation problem—into sub-networks, namely in as many sub-networks as there are simulation-relevant entities (for example: articles and customers in a supermarket-simulation or vehicles and traffic control devices in a traffic simulation). The macro-network is also partitioned in sub-networks (micro-networks) which, for each entity, can be store resp. encapsulated in a corresponding software object. This is called the micro-simulation approach and has the advantage that the complexity on the micro-level is more manageable, because the networks are smaller and the calculation in the networks more is efficient.

The problem in data-mining global models of complex domains is that the resulting models either lack of details or are far too complex to work with them. A lot of modeling methods are NP-hard which makes it impossible to build global models for the whole domain. In this case one uses probabilistic objects which learn typical patterns of behavior from individual customers, as well as customer groups from consumer data and then forecast their behavior subject to changes in the environment (price changes, etc.). The kernel of the probabilistic objects consists of so-called behavior networks—specialized Bayesian networks—which represent probabilistic knowledge structures and which are extracted from sensor data using “data mining”-methods. The probabilistic objects can be used to simulate “What-if”-scenarios. Using a method for merging behavior networks we can integrate global coherences in our models without loosing the level of detail. In this paper an algorithm is presented which merges behavior networks where global coherences between agents evolve as an effect of the merging.

Bayesian Networks will be discussed in the following:

Suppose we have a dataset D which contains records C₁^{W}, . . . , Cₖ^{W} of states (cases) of world W at time t which consist of a set of values assigned to a set of variables X₁, . . . , Xₙ where Xᵢ∈ [symbol] .

For example, the records Cᵢ could be the observations (sensor input) of an agent of the world it is living in during a certain time period [t, l]. Now we wish to build a model of the agent's experience to let the agent learn from its past.

We could model D with a complete probability distribution P(X₁, . . . , Xₙ) which can be used to calculate the probability of a certain state C of D with any specific value v₁ assigned to X₁ and v₂ assigned to X₂ and so on. With such a distribution the agent is able to forecast the probability of success of a certain action based on the experience in the past.

In most cases this probability distribution is totally impractical because of its size. The size of a table which stores the probability distribution increases exponentially with the number of variables and values. Therefore we use Bayesian networks to model D or more precisely Wᵢ which is the view of the world of agent Aᵢ.

A Bayesian network (or Belief network) is a directed acyclic graph (DAG) G=(V, E), where each node Vᵢ corresponds to a variable Xᵢ∈X₁, . . . , Xₙ which has a finite set of mutually exclusive states s₁, . . . , sⱼ. A set of directed edges Eᵢ=(Vₓ, V_{y})∈E₁ . . . Eₙ connects the set of nodes Vᵢ. Each node is connected to a probability distribution P(Xᵢ|Πₓᵢ) where Πₓᵢ is the set of Xᵢ's parents in G. Formally a BN over W is a pair B=(G, PD) where G is the graph and PD is a set of conditional probability tables (CPT). Bayesian networks model a joint probability distribution which is calculated over all variables X₁, . . . , Xₙ as calculated in FIG. 5.

The idea of Bayesian networks in respect to general probability distributions is to encode only dependent probabilities and to eliminate conditional independent relations. Each variable Xᵢ is independent of its non-descendants, given its parents. To perform the task of computing the probability of each value of a variable as described above, the theory of Bayesian networks provides us methods to infer new knowledge. With a conventional probability distribution it would be only a simple look up in a table. In the case of a Bayesian network we need a more complex inference algorithm. In addition BN can handle unknown cases by a generalization of D. But the less space advantage is bought dearly by higher computational costs.

To model all entities of a complex domain we developed a probabilistic holonic multiagent system (PH-MAS). The PH-MAS consists of a set of agents Aᵢ={A₁^{a}, . . . , Aₙ^{z}} with different agent types AT={a, . . . , z}, a repository object RA and a set of agent environments AE={AE₁, . . . , AEₗ}. The agent environments are installed on computers in a network and can manage sets of agents Aⱼ⊂Aᵢ. The AE can receive agents, initialize new agents and remove agents. This is necessary because an agent is usually unable to remove itself while other agents hold references to the agent. Furthermore agents can't simply jump from one computer to another.

An infrastructure that receives and executes agents and handles security issues is required. The repository object RA provides white page and yellow page functionality to all agents and to all users of the system. The MAS knows different types of agent grouping and in particular the method of holonification.

Each agent can be part of one or more holons (set of merged software-agents) Hᵢ with equal agent types {A₁^{x}, . . . , Aₙ^{x}} or different agent types {A₁^{a}, . . . , Aₙ^{z}}. The RA manages references to all parts of the PH-MAS RA_{Ref}:={Ref(Aᵢ)}∪{Ref(Hᵢ)}∪{Ref(AEᵢ)}∪{Ref(WSᵢ)} where WSᵢ are the world servers on which the agents have access.

The second innovation is the probabilistic holonic agent architecture. Such an agent A=(F, S) has a new probabilistic knowledge base (KB) with two components: the fact knowledge component F and the structural knowledge component S. S:={BHᵢ} is a set of behavior networks BH which are defined as tupels (B(D_{[t,l]}), D_{[t,l]}, D_{>l}, DK), where B(D_{[t,l]}) is a set of Bayesian networks based on the agents past experience. D_{[t,l]} is the agent's past sensor data (stored in a dataset), D_{>l} is the agent's current sensor data which is still not integrated in the networks and DK is the domain knowledge which is integrated into the networks.

Each dataset of a behavior network corresponds to a time interval [t, l]. Therefore the networks have a specific time state T_{BH}={t, l, k, b} where t is the start point of knowledge gathering, l is the last point in time from which sensory data is included into the network, k is the number of sensory samples from the world and b is the time basis—the period of time between world samples.

To give the agents a deeper understanding about the information in the networks we give the nodes in a network a semantic. A concept of the agent's world W is represented by one node or a sub-network of nodes in a behavior network.

To keep the knowledge about the semantic of a node Vᵢ, each node can have one or more references to other agents Vᵢ←{Ref(A₁), . . . , Ref(Aₙ)} which realizes originally the concept.

In addition a node Vᵢ can have a tag stᵢ∈DK which describes the semantic of this single node Vᵢ←stᵢ. For example a node with the name “UnitsOfItemX” gets a semantic tag with the meaning units.

The structure of a Bayesian network doesn't implicitly express casual dependencies, but to make a network manageable by human user this should be a main goal in construction. Another assumption is that causal reasonable structures also minimize the complexity of networks. To abide to the structure of a network during merging processes and to keep the complexity as small as possible we introduced another tag that models the causality of a node Vᵢ←ctᵢ∈DK.

Each node gets one of the following types: {inout, input, output, normal}. Input node means that the node is an input node for a sub network and that nodes from other sub networks are allowed to connect to an incoming edge. Output node means that the node can have outgoing edges from the current sub network to another. Inout means that this node is an input as well as an output node. Normal nodes are inner nodes of a sub network and have only edges from and to nodes inside a sub network, while connections to other sub networks are not allowed.

All edges Eᵢ of G have mutually exclusive edge types ET⊂DK that define whether an edge is a proposed, a forbidden or a forced edge. These edge types are used to model the user's (partial) domain knowledge. If a user assumes a relationship between two nodes, but isn't 100% sure about it, then he can insert a proposed edge. Proposed edges are verified with the MDL score and only inserted if the total score of the network increases. Forbidden edges are used to restrict the search space of the structure learning algorithm and to forbid obvious wrong edges. Forced edges are inserted in either case even if the total score decreases. In addition to the edge types the user can specify whether an edge is directed or undirected. Since Bayesian network allow only directed edges, undirected edges are also tested with the MDL score to decide which direction results in a better network.

With this kind of behavior networks we are able to model agent-oriented hierarchical networks with time dependencies and semantics. Suppose we have a set of agents which are collaborating on a problem. In many cases the solution can only be found if the agents share their whole knowledge with each other. Using traditional communication and negotiating protocols, this process is extremely inefficient.

To deal with this fact we use the concept of holonification where agents are able to group together to a so-called holon. A holon is a special group agent where the agents give up parts of their autonomy and commit to a joint goal. One of the holon members or a new agent becomes the head of the holon and represents it as a single agent to the outside.

In the following we describe a method where the members of a holon pass parts of their knowledge to a clone which merges the knowledge of the agents and integrates it in its KB. As described above the knowledge bases of the probabilistic agents consist of sets of behavior networks.

Because the complexity has been broken down to a multitude of small networks many of the probabilistic dependencies between the entities contained in the macro-network are lost. The dependencies which exist between most entities are relatively irrelevant for the simulation process because they only influence each other in their behavior minimally. Due to this, these influences do not have any substantial effect, as they are neutralized by the influences of other entities. Between some entities however, there are simulation-relevant dependencies resp. significant correlations. In order to consider these in the simulation the merging method is necessary (See method B).

Method B: Merging the Entities:

For entities which correlate in their behavior, one can merge the behavior networks of these entities into a larger network (meta-network) using a bottom-up approach and then encapsulate it in a superordinate object which represents the set of correlating entities. The same principle can be used in order to generate statements about groups of entities which do not necessarily correlate with one another. This increases the complexity of the micro-simulation approach, but one distinctly remains below the complexity of the macro-network, because with Method A one only queries those individual objects with their micro-networks and those group resp. meta-objects with their meta-networks which are absolutely necessary for the simulation problem.

Method for Merging Probabilistic Objects:

Determining Maximum Equal Sub-Networks is Shown in FIG. 1.

In FIG. 1 you see two software-agents with behavior networks inside which we wish to merge into one holon agent. In the first step we have to determine all maximum equal sub networks of the agents, because these parts do not have to be merged. Usually a lot of nodes are equal for example the time nodes day, weekday, month etc. The information about which nodes are equal is also necessary in order to know where to connect unequal nodes. If no nodes are equal then the networks are not merged and stored as two isolated sub networks. But in a later step new edges between the two networks can be found and added, which can result in a single overall network.

To find all maximum equal sub networks we take all root nodes and compare them with each other.

Two nodes Vᵢ, Vⱼ are equal if their conditional probability tables (CPT) and the parent nodes Pa(Vᵢ)=Pa(Vⱼ) are equal. This means, that all of the possible paths (Vᵢ→Vᵢ₊₁→ . . . →Vₙ=root nodes) to the root nodes must be the same. The reason for this is, that changing probability distributions (CPT) of Pa(Vᵢ) can result in different CPT of Vᵢ after inferences have been carried out.

If two root nodes with equal CPTs are found then the algorithm continues recursively with the child nodes of the equal nodes.

Two nodes Vᵢ, Vⱼ are equal if the conditional probability tables (CPT) and the incoming neighbors Pa(Vᵢ)=Pa(Vⱼ) are equal. This implies that all possible paths (Vᵢ→Vᵢ₊₁→ . . . →Vₙ=root node) to root nodes must be equal. The reason is that a different probability in a CPT of Pa(Vᵢ) can result in different CPT of Vᵢ after inferences.

This method is repeated for all equal and unvisited root nodes. We use node colors to mark which nodes are already visited, which are unvisited and which nodes are equal and hence taken.

The binary operator == is true iff the CPT of two nodes are equal. The operator doesn't test full equality of BN nodes as defined above.

After the first run of the loop in FindMaxEqualNets(G_{B}) all taken nodes represent one maximum equal sub network. All found networks after n runs are disjointed per definition.

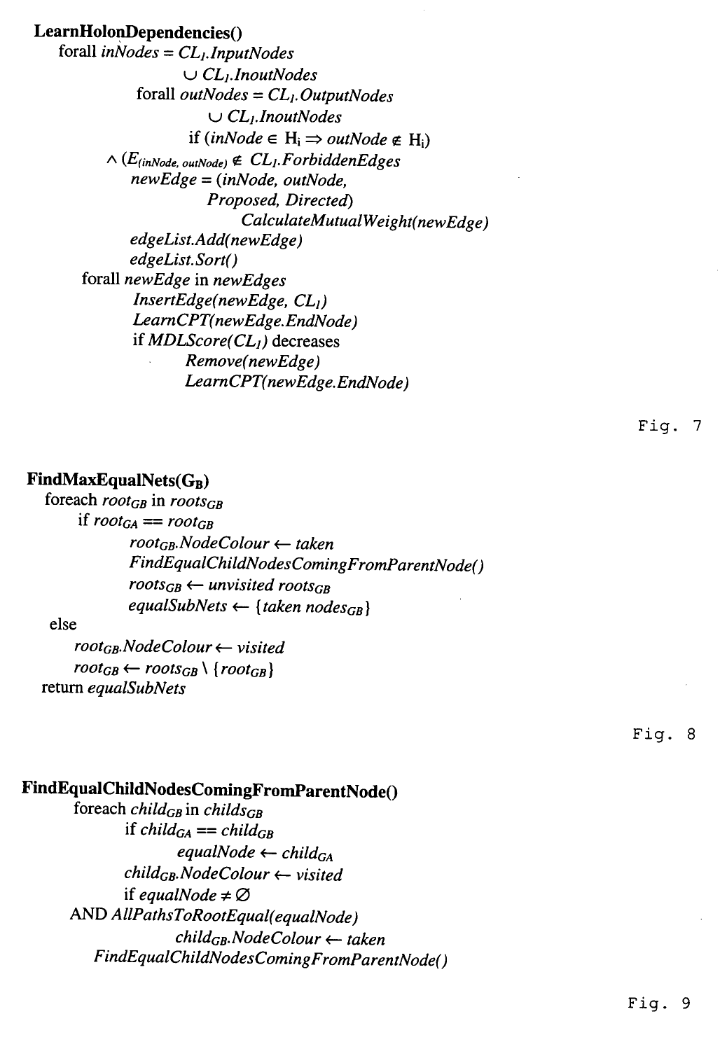

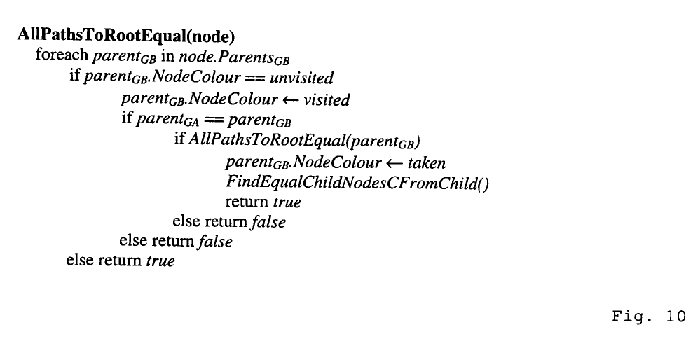

After equal root nodes are found through the method in FIG. 8 the method FindEqualChildNodesComingFromParentNode( ) (FIG. 9) is called to test all child nodes. Child nodes are equal if their CPT and all possible paths to root nodes are equal (AllPathsToRootEqual(equalNode)). If equal nodes are found the method is called again for all child nodes:

The Boolean function AllPathsToRootEqual( ) tests equality for all nodes on paths to root nodes. If equal parent nodes are found then the method FindEqualChildNodesCFromChild( ) is called to find also all equal child nodes of this parent node. FindEqualChildNodesCFromChild( ) is similar to FindEqualChildNodesComingFromParentNode( ) except that we have to test whether a child node was visited before because beforehand we come from a child node and we don't want to run in cycles.

Merging Probabilistic Networks:

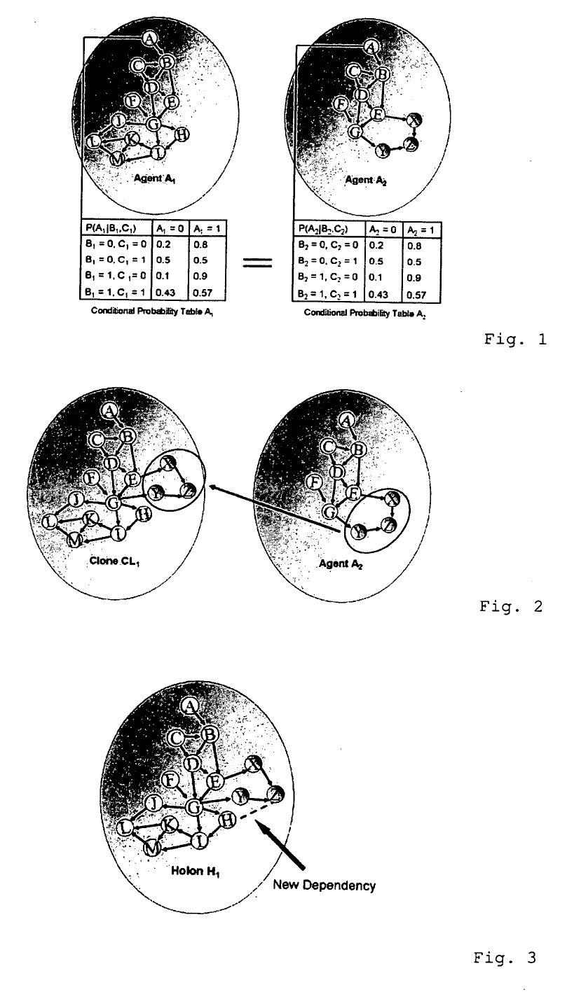

After the identification of all maximum equal sub networks and therefore all equal nodes V_{E}={V₁, . . . , Vᵢ₋₁} we can identify the unequal parts of the network V_{UE}={Vᵢ, . . . , Vₙ} of agent A₂ (see FIG. 2). Before these parts are connected to network G₁ of agent A₁ a clone CL₁ of A₁ is produced.

For all V_{UE} in A₂ copies are created in the network of CL₁. Then copies of all edges between V_{UE} are added between the new nodes in CL₁. These edges always point from V_{E} to V_{UE}. If the direction would be reversed then nodes of V_{UE} would be parents of V_{E}. But according to the definition of equality of sub networks all parents of V_{E} must be in V_{E} too. After the merging process no CPT must be updated or relearned. All nodes in V_{E} are unaffected because no new edges point to nodes in V_{E}. The CPT of V_{UE} do not have to be updated either, because no new edges to nodes in V_{UE} are added.

In the next step we merge the agent's raw sensor data of the past D_{[t,l]} and the current not integrated sensor data D_{>l}.

The merging of datasets is rather simple since all nodes of B are represented as columns in D. The data sets are merged by adding the columns of the unequal nodes in D₂∈A₂ to the corresponding data sets in CL₁.

It is possible that no equal nodes are found. Then the network of A₂ is added to CL₁ as an isolated sub network. In the next step of the holonification algorithm new relations can be discovered and new edges be inserted.

Discovering and Integrating Dependencies:

In the next step we start searching for dependencies between the merged agents. We do this by starting with a cross-validation between the old part of the network and the new parts of the network. For all possible edges between all output and inout nodes and all input and inout nodes and if an edge is not forbidden and lies between holon sub networks the mutual weight is calculated. Starting with the highest weight the edges are successively inserted into CL₁. After an insertion the CPT of the end node of an edge must be relearned. If the MDL score of the whole network of CL₁ increases then the edge is kept, otherwise it is removed.

Through the method in FIG. 7 we have a holon of the two agents which contains more knowledge than the sum of the single agents and which has for many tasks a far more efficient structure than a set of single agents. The existence of a holon is usually only temporary until the current goal is reached and one can assume that it will soon no longer be needed. FIG. 3 shows the corresponding derived dependencies.

Method C: The Simulation Process:

In order to further reduce the complexity of the calculations, one can query the objects and group-objects sequentially resp. have their behavior calculated from the networks encapsulated in them, because the correlations are stored in the meta-networks and thus, correlations between the software-objects resp. entities must not be calculated during the run-time of the simulation. Moreover, not all of the software-objects with their micro- and macro-networks must be kept in the computer memory at the same time which makes the system scalable.

In the first step, the system requires a start scenario in which basic parameters are defined. These form the basis for the first simulation cycle. A start scenario consists of the description of the current situation, assumptions pertaining to future external influences, a definition of goals and the measures and promotions planned.

A so-called scenario-object in which all of the required simulation parameters are stored is created to generate the start scenario. All changes and promotions are managed here by special promotion objects. Assumptions about future external (environmental) influences on the simulation are also noted here. In addition, one can specify details about the simulation period and the key data to be calculated for evaluation.

Via simulation, a prognosis about the effects of the scenarios is made on the basis of the start scenario. Usually the prognosis is repeated with further simulation cycles using different values in order to evaluate all of the defined scenario variations.

The actual simulation and prognosis consists in the fact that one presents the software-objects with the current scenario variation, at the beginning of the start scenario and lets them react according to their individual patterns of behavior. All of the software-objects react to the parameters and external influences defined in the scenario according to their knowledge coded in their behavior networks.

During the simulation, the dependency-networks of the entities are merged according to the simulation parameters, configured and the changes propagated over the network. To do so, sequences of network configurations must be generated for many simulation objectives. These are then evaluated one after the other. A network configuration consists of a series of evidences and likelihoods (probability distribution) which describe a certain situation. These evidences and likelihoods are put into the network and then propagated by it. The results are interpreted by a software-object and transformed into meaningful result values. These result values can be combined to form a global result value.

Method D: Generating the Probabilistic Net:

Usually there is an optimal set of edges and nodes in a probabilistic network with which a very high prognosis quality with a manageable computational complexity can be achieved. If one removes edges or nodes, then the quality of the prognosis is significantly reduced. If however, one adds nodes or edges, then the quality of the prognosis does not significantly increase, whereas the computational complexity does worsen significantly. In order to generate optimal networks, the following method is used:

Learning Bayesian Nets

The problem of learning a Bayesian network can be defined in this manner: with the given training set D as an example of an entity from W, a network B=(G, PD) must be found which best corresponds to D. To find such a network one needs three things: first a measurement function, which measures the quality of a network in relation to the given the data set D, second, a heuristic search algorithm, which goes through the space of possible networks (with their various topologies and probability distributions) and preferably specifies the best global solution and third a method for learning probabilities in the set from conditional probability tables CPT.

Learning Bayesian Networks is a NP-complete problem; even when complete data is available. The so-called MDL-measurement function (MDL from “Minimum Description Length”) is favored for evaluating the quality of the network.

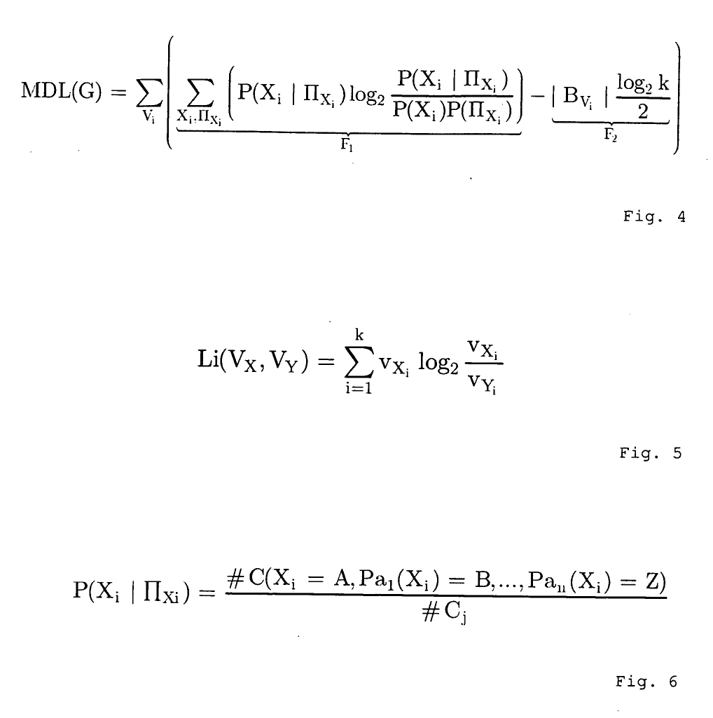

The MDL-measurement function (See FIG. 4) is rooted in universal coding. The goal of universal-coding is to find a model M from D which can be used to produce a compact version of D. The overall description length is the size of the compressed version of D. The MDL-measurement function minimizes the overall description length of M. In the field of Bayesian Network the MDL-function balances out the complexity of a network with the accuracy of the representation of D in a network of B. |BVᵢ| is the sum of the number of probabilities of the CPT of the der Vᵢ and k is the number of data sets in D. The first part F₁ of the formula maximizes the accuracy of the networks, while the second part F₂ is a “penalty value”, which prevents networks which are too large and “over-trained”.

As mentioned above, one also needs a heuristic search algorithm in order to complete the learn algorithm for the generation of the Bayesian network structure. To find good network structures, one first starts with a cross-validation method. One calculates the logarithmic probability (mutual weight) for each possible pair (Vₓ, V_{y}) according to the formula in FIG. 5 and saves it in a list. The logarithmic probability is similar to the MDL-measurement function, can however in contrast to it be directly calculated from the dataset D without the network B. Then the logarithmic probability list is sorted decreasingly according to the highest value. Now one begins a so-called “Greedy”-search. One takes the first entry in the logarithmic probability list, adds an edge between the two nodes and calculates the MDL-value. Then the direction of the edge is reversed. When one of the directions increases the overall MDL-value of the network, then the edge with the higher value is taken. This method is then repeated for all of the node pairs in the list.

Finally, one needs a function for learning the probability P(X₁, . . . , Xₙ) of an event Cᵢ from D, in order to fill the CPT of the network. This is very simple in the case of complete data. The probability

P(Xᵢ=A|Pa₁(Xᵢ)=B, . . . , Paₙ(Xᵢ)=Z) is calculated with the formula in FIG. 6.

Which corresponds with the number of combinations of states of the influence factors, by which Xi=A holds and the parents from Xi are Pa₁=B, . . . , Paₙ=Z, divided by the total number of all possible combinations of states of the influence factors in D.

The resulting BN models the experience and the knowledge from a probabilistic object regarding its sensor-data during the time interval [t, l].

The embodiments described here do not represent a constraint to the extent of protection. They serve only to better clarify and understand the invention. The extent of protection is defined by the following claims and is assessed according to the knowledge of an expert in this field.

### REFERENCES

The following references are part of the application and integrated in it:
[CDS99] Robert G. Cowell, A. Philip Dawid, David J. Spiegelhalter. Probabilistic Networks and Expert Systems. Springer Verlag 1999.
[Che02] Cheng, J., Hatzis, C., Hayashi, H., Krogel, M., Morishita, S., Page, D. and Sese, J., KDD Cup 2001 Report. ACM SIGKDD Explorations Volume 3, Issue 2, January 2002.
[GSV99] C. Gerber, J. Siekmann and G. Vierke. Holonic Multi-Agent Systems. Technical Report, Deutsches Forschungszentrum für Künstliche Intelligenz, Journal of Artificial Intelligence 1999.
[Jen01] F. V. Jensen. Bayesian Networks and Decision Graphs. Springer Verlag 2001.
[Nea98] R. E. Neapolitan. Probabilistic Reasoning in Expert Systems: Theory and Algorithms. A Wiley-Interscience Publication. John Wiley & Sons, Inc., New York. 1998.
[Pea88] Judea Pearl. Probabilistic Reasoning in Intelligent Systems. Morgan Kaufmann Publishers INC. 1988.
[FSS03] Fischer, K., Schillo, M., and Siekmann, J.: Holonic Multiagent Systems: The Foundation for the Organization of Multiagent Systems. Proceedings of the First International Conference on Applications of Holonic and Multiagent Systems (HoloMAS'03).
[Chi96] D. Chickering, Learning Bayesian networks is NP-Complete, In Learning from Data, 121-130, Springer-Verlag, 1996.
[CGH94]] D. M. Chickering, D. Geiger, D. Heckerman, Learning Bayesian networks is NP-hard, Technical Report MSR-TR-94-17, Microsoft Research, Microsoft Corporation, 1994.

1. A Computer system with memory and processor for the simulation of the behavior of any entity, whose interdependencies, as well as the resulting system behavior based on sensor data, including:
a memory area with at least one individual software-object which represents one or more real entities and stores the individual behavior of the corresponding entity(ies) using a set of probabilistic networks (PN), wherein a PN models one sub-behavior of an entity as quantified, linear or non-linear dependencies between a set of influence factors and behavior aspects, wherein these influence factors and behavior aspects are represented by corresponding nodes in the PN, wherein the individual behavior is extracted from real data about the entity and its environment using machine learning methods,
a memory area with at least one meta-PN, which represents the dependencies between the entities, wherein these are extracted from real data and stored as linear or non-linear dependencies between the entities in the meta-PN, wherein the meta-PNs are generated by merging local PNs and adding the extracted global interdependencies,
a memory area in which scenarios are defined based in the combination of concrete states of the influence factors, wherein a scenario defined by a time period is represented by a sequence of combinations of concrete states of the influence factors. The simulation of the scenario is initialized by the configuration of the PN on the basis of the combinations of states, wherein the states defined in the scenario are set in the corresponding nodes of the influence factors, wherein the behavior of the entities is determined through the inference-algorithms of the PNs based on the set states of the behavior aspect nodes, wherein the means are available to simulate the global interdependencies between the entities with the meta-PN analog to the local PN.

2. The computer system according to claim 1, wherein the global interdependencies between the entities are stored in superordinate entities representing a set of entities.

3. The computer system according to claim 1, wherein
the software-objects exhibit one or more of the following characteristics: autonomous, reactive, pro-active, mobile, adaptive, communicative, cooperative, wherein
autonomous means that a software-object is capable of carrying out an action at any point in time it chooses (independent of other program instances),
reactive means that a software-object is capable of reacting to external queries or sudden events in real-time,
pro-active means that a software-object can carry out a calculation and initiate actions without an external impulse,
mobile means that a software-object can be moved from one computer to another when necessary,
adaptive means that the software-objects do not have a fixed program flow or fixed data base, but rather can adapt themselves to new requirements by learning new information and behavior,
communicative means that the software-objects can exchange information and instructions with each other,
cooperative means that the software-objects react to the behavior of other software-objects, in order to achieve mutually common goals.

4. The system according to claim 1, wherein the overall behavior of all entities is simulated by combining the individual simulation results of the entities.

5. The system according to claims 1, wherein the modeling and simulation are scalable by combining any group of entities to superordinate entities and wherein superordinate entities can, in turn, be combined to form entities (formation of fractals).

6. The system according to claim 1, wherein means are available for evaluating the simulation results which represent the overall behavior of the simulated entities resp. their reactions to scenario-changes, via a utility function.

7. The system according to claim 6, wherein means are available for searching for scenarios, i.e. combinations of influence factors, using an optimization method, which maximizes the utility function,

8. The system according to claim 7, wherein means are available for interrupting the optimization method at a certain point and issuing a list of the scenarios found up to this point, which maximize the utility function.

9. The system according to claim 8, wherein means are available for selecting one of the issued utility-maximizing scenarios, in order to parameterize the influence factors on the physical instances of the entities in the real world by taking actions, producing physical effects or controlling physical devices as specified in the selected scenario or
an adaptation to the expected overall behavior of the simulated entities is effected by the taking of actions, the producing of physical effects or the control of physical devices.

10. A method for modeling and simulating entities whose interdependencies, as well as the resulting system behavior, can be used to make statements about the real behavior consisting of the following steps:
the real entities are each represented by individual software-objects, wherein such software-objects represent one or more real entities and store the individual behavior of the corresponding entity(ies), wherein this behavior is extracted from real data about the entity(ies) and its(their) environment using machine learning methods, in order to then store the individual behavior within the software-object via a set of probabilistic networks (PN), wherein each PN models one sub-behavior of the entity as quantified linear or non-linear dependencies between a set of influence factors and behavior aspects,
the influence factors and behavior aspects are represented by the corresponding nodes in the PN,
the global interdependencies between the entities are extracted from real data and stored as linear or non-linear dependencies between the entities in the meta-PN,
the meta-PN are generated by merging local PNs and by adding the extracted global interdependencies,
any kind of scenario can be defined based on combinations of concrete states of the influence factors, a scenario defined by a time period will be represented by a sequence of combinations of concrete states of the influence factors,
the simulation of the scenario is initialized by the configuration of the PN with the combinations of states, wherein the states defined in the scenario are set in the corresponding nodes of the influence factors,
the behaviors of the entities are defined by inference-algorithms of the PN on the basis of the set states of the behavior aspect nodes, wherein the global interdependencies between the entities are simulated with the meta-PN analog to the local PN.

11. The method according to claim 10, wherein the global interdependencies between the entities are stored in superordinate entities representing a set of entities.

12. The method according to the claims 10, wherein
the software-objects exhibit one or more of the following characteristics: autonomous, reactive, pro-active, mobile, adaptive, communicative, cooperative, wherein
autonomous means that a software-object is capable of carrying out an action at any point in time it chooses (independent of other program instances),
reactive means that a software-object is capable of reacting to external queries or sudden events in real-time,
pro-active means that a software-object can carry out a calculation and initiate actions without an external impulse,
mobile means that a software-object can be moved from one computer to another when necessary,
adaptive means that the software-objects do not have a fixed program flow or fixed data pool, but rather can adapt themselves to new requirements by learning new information and behavior,
communicative means that the software-objects can exchange information and instructions with each other,
cooperative means that the software-objects react to the behavior of other software-objects, in order to achieve mutually common goals.

13. The method according to claim 10, wherein the overall behavior of all entities is simulated by combining the individual simulation results of the entities.

14. The method according to claims 10, wherein the modeling and simulation is scalable, by combining groups of entities to superordinate entities.

15. The method according to claim 10, wherein superordinate entities are in turn combined to form entities (formation of fractals).

16. The method according to claim 10, wherein the simulation results, i.e. the overall behavior of the simulated entities resp. their reactions to scenario-changes are evaluated by a utility function, in order to search for scenarios, i.e. combinations of states of influence factors, which maximize the utility function by using an optimization method.

17. The method according to claim 16, wherein the optimization method is interrupted at a certain point and a list of the scenarios which maximize the utility function found until then is issued, in order to then by selecting one of the issued utility-maximizing scenarios parameterize the influence factors on the physical instances of the entities in the real world by taking actions, producing physical effects or controlling physical devices as specified in the selected scenario or
an adaptation to the expected overall behavior of the simulated entities is effected by taking actions, producing physical effects or controlling physical devices.

18. Data media, including a digital data structure, which carries out a method in accordance with claim 10, after being loaded into the memory of a computer.
